(19) United States
(12) Patent Application Publication
(10) Pub. No.: US 2012/0068471 A1
(43) Pub. Date: Mar. 22, 2012

(54) ENERGY CONVERSION SYSTEM

(76) Inventor: John S. Robertson, Portland, OR (US)

(21) Appl. No.: 13/210,182

(22) Filed: Aug. 15, 2011

Related U.S. Application Data
(63) Continuation of application No. 12/406,894, filed on Mar. 18, 2009, now abandoned.
(60) Provisional application No. 61/070,065, filed on Mar. 18, 2008.

(51) Int. Cl. H02K 7/18; B01J 19/12

(52) U.S. Cl. 290/1 A; 422/148

(57) ABSTRACT

A system of hardware and controls, know as a Hydrogen Hub, that absorbs electric power from any source, including hydropower, wind, solar, and other energy resources, chemically stores the power in hydrogen-dense anhydrous ammonia, then reshapes the stored energy to the power grid with zero emissions by using anhydrous ammonia to fuel diesel-type, spark-ignited internal combustion, combustion turbine, fuel cell or other electric power generators.

### CROSS-REFERENCE TO RELATED APPLICATIONS

This is a continuation of Ser. No. 12/406,894 filed Mar. 18, 2009 which claims priority to prior-filed provisional application Ser. No. 61/070,065, titled “Energy Storage and Conversion Systems,” filed on Mar. 18, 2008. The disclosures of which are incorporated herein by reference in their entireties.

### BACKGROUND

Energy supply and demand is typically cyclic being influenced by both market and natural forces. For example, energy supply from renewable energy sources may be decreased or increased depending on circumstances of weather or human intervention. Hydroelectric power generation may be decreased by both a naturally lower mountain snowpack and a manmade reduction in outflow through the turbines of a hydroelectric dam. As another example, energy supply may drastically increase during times of extreme temperature conditions (whether high or low) or when spot prices for electric power rise. Finally, power generation capacity and consumption may be affected by less-obvious influences, such as a government's environmental policy, which may reward or punish energy production under certain circumstances (e.g. rewarding production with renewable energy sources or punishing production under unfavorable weather conditions or with nonrenewable energy sources). Therefore, there is a need for a system of energy production and distribution that can account for and dampen some of the fluctuations in a system of energy supply and demand as measured by both energy production and energy pricing.

### SUMMARY

The Hydrogen Hub (Hub) is an invention designed to help provide a unique system solution to some of the most serious energy, food and transportation challenges we face in both the developed and developing world. Hubs create on-peak, zero-pollution energy, agricultural fertilizer, and fuel for transportation by synthesizing electricity, water and air into anhydrous ammonia and using it to help create a smarter, greener, and more distributed global energy, food and transportation infrastructure.

This patent describes the operational elements, subsystems and functions of a Hydrogen Hub. It also describes six embodiments of Hub configurations, detailed below, that are designed to insure Hubs can help meet a wide range of energy needs and other challenges. These six embodiments include:

(I) Land-Based, Integrated Hubs Fully Connected to the Power Grid. In this configuration, Hubs shape and control power demand, provide energy storage, then create on peak power generation at a single location.

(II) Land-Based, Disaggregate Hubs Fully Connected to the Power Grid. In this configuration, key Hub processes are disaggregated, deployed to separate locations, and connected to the power grid. This is done to maximize the operating efficiency of both the ammonia synthesis and generation functions. It also allows for strategic, large-scale placement of each function to precise locations on the power grid where they can achieve the highest possible value for capturing off peak resources, stabilize the power grid, and provide zero-emissions power generation at the source of load.

(III) Land-Based, Disaggregated Hubs Partially Connected to the Power Grid. In this configuration, Hub ammonia synthesis operations are deployed to isolated locations to capture high value wind and solar resources that may otherwise be lost because of the capital cost of transmission construction to reach the site, or long delays or outright prohibition of transmission construction across environmentally sensitive areas. The renewable ammonia created at these sites is then transported to grid-connected Hydrogen Hub generation locations at or near the center of load.

(IV) Land Based, Integrated Hubs, Operating Independently from the Power Grid. Land-based hubs, referred to here as Wind-Light Hubs, may operate independently of the power grid in smaller, isolated communities worldwide. In this configuration Hub functions are integrated into a singular design that captures intermittent wind and solar energy, water and air and turns these resources into predictable electricity, renewable ammonia, and clean water for villages and communities with little or no access to these essential commodities.

(V) Water-Based, Disaggregated Hubs Partially Connected to the Power Grid. Hydrogen Hub ammonia synthesis operations, referred to here as Hydro Hubs, can be placed on production platforms on large-scale bodies of fresh water or in the ocean. Then the resulting ammonia made from electricity from surface wind, high altitude (jet stream) wind, wave, tidal solar, water temperature conversion, or other renewable resources can transported by barge or ship to Hub generation locations. Here the renewable anhydrous ammonia will fuel grid-connected Hub generation with zero emissions near the center of load.

(VI) A Global Hydrogen Hub Energy-Agriculture-Transportation Network. It will take generations to achieve, but a fully integrated network of Hydrogen Hubs, operating on land and on water, can help capture large-scale renewable and other energy resources, stabilize power grids, distribute on peak, zero-pollution energy to load centers, create farm fertilizer from all-natural sources, and create fuel to power cars and trucks with zero emissions. A Hydrogen Hub network can work on a global scale—reaching billions of people in both the developed and developing world.

All six embodiments are described in this patent.

### BRIEF DESCRIPTION OF THE DRAWINGS

FIG. 1 depicts one embodiment of an energy conversion module according to the present disclosure.

FIG. 2 depicts the energy conversion module of FIG. 1 as part of an energy conversion and transportation system according to the present disclosure.

FIG. 3 depicts the extreme fluctuations possible in electrical generating capacity for a typical wind-based electrical generation apparatus useful in the module of FIG. 1 or the system of FIG. 2.

FIG. 4 depicts typical wind resources and power transmission line capacities in an exemplary country that could implement the module of FIG. 1 or the system of FIG. 2.

FIG. 5 depicts one embodiment of a module of FIG. 1 configured to derive at least a portion of its input energy from wind power.

### DETAILED DESCRIPTION

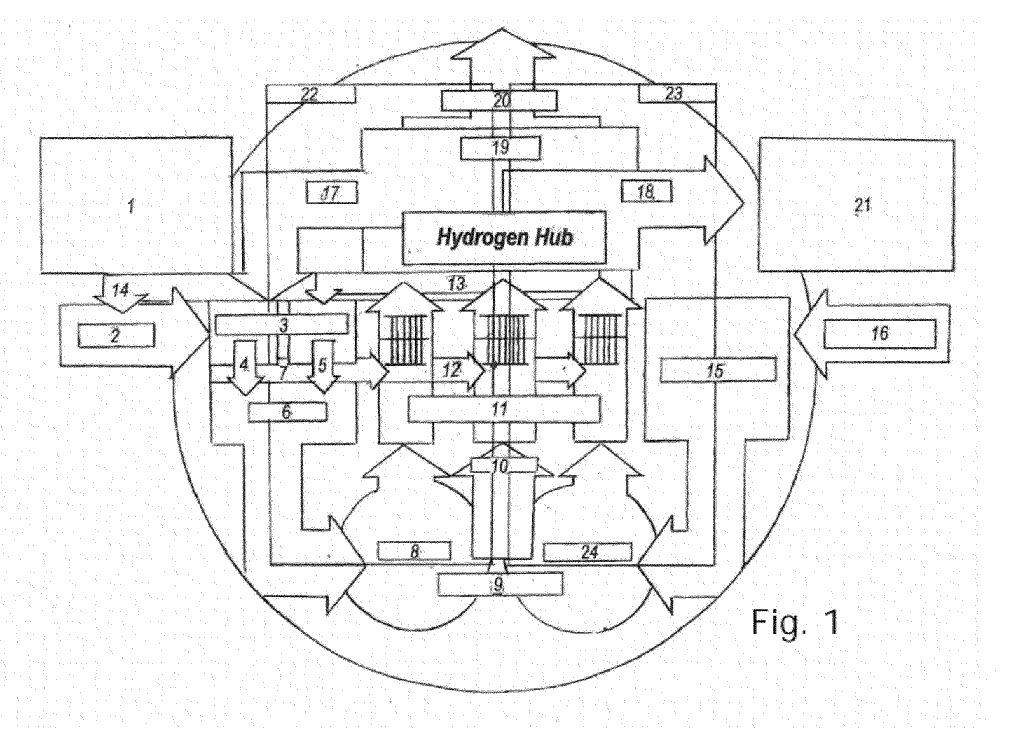

I. LAND-BASED, INTEGRATED HUBS FULLY CONNECTED TO THE POWER GRID. We first describe a fully integrated Hydrogen Hub connected to the power grid, one embodiment of which is illustrated in FIG. 1. Grid-connected hubs may capture off-peak energy from many sources, including intermittent renewable energy from wind and solar power sites. Hubs have the flexibility to do this at key locations on—and at the demand of—the power grid.

This lower value, off peak power is captured as chemical energy by means of synthesizing electricity, water and air into anhydrous ammonia (NH3). Anhydrous ammonia is among the densest hydrogen energy sources in the world—50% more hydrogen dense than liquid hydrogen itself. Hydrogen gas would have to be compressed to 20,000 pounds per square inch—not possible with today's tank technology—to equal volumetric energy density of liquid anhydrous ammonia. The anhydrous ammonia is then stored in tanks for later use either as a fuel for on peak electric power generation at the integrated Hydrogen Hub site or sold for use as a fertilizer for agriculture, or for other uses.

A Hydrogen Hub is a system of hardware and controls that absorbs electric power from any electric energy source, including hydropower, wind, solar, and other resources, chemically stores the power in hydrogen-dense anhydrous ammonia, then reshapes the stored energy to the power grid on peak with zero emissions by using anhydrous ammonia as a fuel to power newly designed diesel-type, spark-ignited internal combustion, combustion turbine, fuel cell or other electric power generators.

If the electricity powering the Hub ammonia synthesize process comes from renewable energy sources, we refer to this product as “green” anhydrous ammonia. When anhydrous ammonia is used as a fuel to power Hydrogen Hub generation, the emissions are only water vapor and nitrogen. There is zero carbon or other pollutant emissions from Hydrogen Hubs power generation using anhydrous ammonia as a fuel source. Under certain operating conditions there is the potential that nitrogen oxide might be created during combustion. But if this occurs, it can be easily controlled and captured by spraying the emissions with ammonia produced by the Hub (see below).

Hydrogen Hubs may be designed to offer a powerful, high-capacity renewable energy source that can be distributed by power system managers to precisely when and where the power is needed—all controlled and tracked by a new process described in this patent. Hubs can be scaled up or down in size. They can be designed to be portable—placed on truck beds to be quickly transported to locations of need in an energy emergency.

Taken together this integrated Hydrogen Hub system helps stabilize the power grid, increases the value of intermittent renewable energy resources, and puts off the need for new large-scale energy systems built to meet peak loads. Hub generation sites can also save billions of dollars in transmission congestion fees and new transmission and distribution facilities, constructed to bring power from distant locations to the center of load. Hubs can serve as a highly distributed, high capacity, demand-side resource serving the power needs of homes, blocks, neighborhoods or cities.

Natural Fertilizer: In addition to providing unique power benefits, the anhydrous ammonia created by Hubs can be used as fertilizer for agriculture. This creates the opportunity—unique among energy sources—for the cost of Hydrogen Hub development to be shared by at least two large-scale industries, energy and agriculture. This reduces the overall cost of Hubs to both groups and potentially creates savings for consumers of both energy and food. As a Hydrogen Hub network develops, there is also the possibility this partnership can extend to the transportation industry, as described in Section VI below.

If the anhydrous ammonia created by the Hub is made from renewable electricity, hydrogen from water and nitrogen from the atmosphere, we refer to it herein as “green” ammonia. Green anhydrous ammonia can be considered a “natural” or “organic” fertilizer. This can have a particularly high value in today's marketplace.

By contrast, global ammonia is one of the most highly produced inorganic materials with worldwide production in 2004 exceeding 109 million metric tons. The U.S. is large importer of ammonia. The People's Republic of China produced over 28% of worldwide production followed by India (8.6%), Russia with 8.4% and the United States at 8.2%. About 80% of ammonia is used as agricultural fertilizer. It is essential for food production in this country and worldwide. Virtually all 100+ million tons of anhydrous ammonia created in the world each year is made by a steam methane reforming process powered by carbon-based natural gas or coal. This method of producing ammonia constitutes one of the single largest sources of carbon in the world.

If the cost of power into the Hub ammonia synthesis process is five cents a kilowatt-hour (a typical year-round industrial rate for a full requirements customer of the Bonneville Power Administration), for example, it is estimated ammonia in the Pacific Northwest could be available for $900 a ton. By contrast, in 2008 the price for carbon-based global anhydrous ammonia ranged between $600 and $1,200 a ton in the Northwest.

The five-cent a kilowatt-hour price of power to synthesize ammonia can drop the price of produced ammonia in the Northwest to about $500 a ton if a new synthesis technology like Solid State Ammonia Synthesis (see 4.2 below) is employed. Using spring off peak prices of power at or below 2 cents a kilowatt-hour, the price of ammonia from this excess renewable energy would plunge even further, not counting the potential for carbon credits or a reduced capital cost due to a joint power/energy alliance to share in the cost of financing and building Hydrogen Hubs.

Firm and non-firm hydropower and, increasingly, wind energy dominate the energy output of the Bonneville Power Administration. This is also true of most electric energy created in the Northwest. Therefore, most of the ammonia made at Hydrogen Hub ammonia synthesis plants in the Northwest could be considered partly or entirely green. Because Hubs can capture intermittent renewable energy otherwise lost to the system, Hubs may qualify for carbon credits, renewable portfolio standards, and other benefits. Because the green ammonia created by Hubs and sold to farms displaces global ammonia, referred to in this patent as “blue” ammonia, created from carbon sources, it also may qualify for carbon credits and other environmental benefits. This could further lower green ammonia prices.

Other uses for Hub-synthesized ammonia are in refrigeration, power plant stack cleaning, as an alternative fuel for car and truck transportation (described below), and many other recognized commercial purposes.

INTEGRATED HYDROGEN HUB SYSTEMS AND FUNCTIONS. A fully integrated, grid-connected Hydrogen Hubs system is broken down into nine major categories: 1) Electronic Controls; 2) Acquisition, Storage and Recovery of Hydrogen; 3) Acquisition Storage and Recovery of Nitrogen; 4) Synthesis or Acquisition of Anhydrous Ammonia; 5) Acquisition, Storage and Recycling of Water; 6) Acquisition, Storage and Injection of Oxygen; 7) Ammonia Storage; 8) Electric Power Generation; and 9)

Monitoring, Capture and Recycling of Generation Emissions.

Within these nine categories this patent identifies a number of subsystems and related functions described below that can be part of the Hydrogen Hub technology process, depending on specific Hub operating conditions, and the needs of individual utilities, energy companies and other potential purchasers of the Hydrogen Hub. These specific subsystems and functions are outlined below.

I. (1) Electronic Controls

Hydrogen Hubs can form an integrated subsystem of “smart,” interactive power electronics designed to control, monitor, define, shape and verify the source of electric energy powering Hydrogen Hub technology both on site, or remotely, and in real-time.

I. (1.1) Hub Power Sink System (HPS)

The HPS system will allow the grid operators to remotely control and manage the ammonia synthesis operations with on, off and power shaping functions operating within pre-set parameters. The HPS also may be electronically connected to emerging technologies designed to better predict approaching wind conditions, the likely duration and velocity of sustained winds, and wind ramping events within the specific geographic location of the wind farm. The HPS will allow Hub ammonia synthesis operations that can be located adjacent to wind farms, to better operate as an on-call energy sink (see 4.3 below) and as a demand-management tool. With HPS “smart” technology, Hub synthesis operations can mitigate transmission loadings and reduce transmission congestion fees by triggering idle Hub synthesis operations. The HPS can take advantage of Hub operating flexibility to maintain temperatures in the ammonia synthesis heat core to allow rapid response to changing intermittent energy patterns, or to rapidly bring synthesis system core temperatures from cool to operational as wind systems approach the specific geographic area of the Hub site. HPS also will allow Hubs to respond to periods of large-scale renewable (and non-renewable) generation, peak hydropower, wind ramping events and other periods of sustained power over-generation that can lower prices and cause grid instability.

I. (1.2) Hub Power Track (HPT)

The HPT system will establish the real-time tracking of the source of electricity powering the Hub ammonia synthesis operation. Increasingly, utilities are being required to track the sources of electricity flowing across their power systems at any given time. HPT will track and integrate this information in real time at the precise location of the Hydrogen Hub site.

For example, it is the early spring day at 1:15 p.m. in the afternoon. HPT tracks the fact that 70% of the power at the location near Umatilla, Oregon comes from firm and non-firm hydropower sources, 15% from wind resources adjacent to the site, 10% from the Energy Northwest nuclear plant at Hanford, and 5% from the Jim Bridger coal plant in Wyoming. HPT will track this information continuously. HPT will log the fact that the ammonia produced at the site at this particular moment was, for example, 85% from renewable sources, 10% from non-renewable, carbon-free sources, and 5% from carbon-based coal. With this information, the Hub manager can determine how much of the ammonia synthesized by the plant can be considered green and thereby potentially qualify for carbon credits, meet renewable portfolio standards, and other similar benefits. The manager also knows what percentage of the ammonia may be subject to carbon taxes or costs—in this case a total of 5%. If all electricity into the Hub comes from wind farms, for example, the ammonia synthesized by the Hub is labeled as green ammonia and may qualify for carbon credits, renewable energy credits, portfolio standards and other benefits associated with green power generation. By contrast, if HPT records and verifies that power into the Hub came exclusively from coal plants during a specified period, the ammonia produced by the Hub would not qualify for renewable benefits and may be subject to carbon tax or cap and trade costs.

The tank of ammonia put into storage is matched with a “carbon profile” provided by HPT. This allows the Hub manager to track the green content of the fuel later used to power the Hub generation process (see below) or used as a fertilizer on local farms. Hubs may seek an independent third party to manage the HPT program to assure accurate, transparent, and independent confirmation of results—an official seal of approval creating confidence in a green ammonia exchange market (see 1.4 below).

I. (1.3) Hub Code Green (HCG)

The HCG uses the data from HPT to place physical identification codes on tanks of ammonia created by the Hub. The HCG then tracks the movement of that ammonia if it is sold or traded with other non-Hub-produced tanks filled with “blue” ammonia. This integrated tracking system allows for the cost-effective storage of green ammonia among and between Hydrogen Hubs and the agriculture industry, for example, with other tanks of “blue” global ammonia made from carbon-based sources. The combination of the HPT and HCG system is essential to establishing a transparent, highly efficient and well-functioning Hydrogen Hub green ammonia fuel market.

I. (1.4) Green Ammonia Exchange (GME)

The HPT and HOB systems together create the independently verified and transparent data that forms the foundation for the GME tracking system—a robust regional, national and international green ammonia trading exchange. The GME allows green ammonia to be purchased, sold, exchanged or hedged, physically or by contract, between parties. This exchange cannot exist without Hydrogen Hubs and their unique ability to create, track, code green ammonia fuel in real time.

I. (1.5) Green Ammonia Derivatives Market

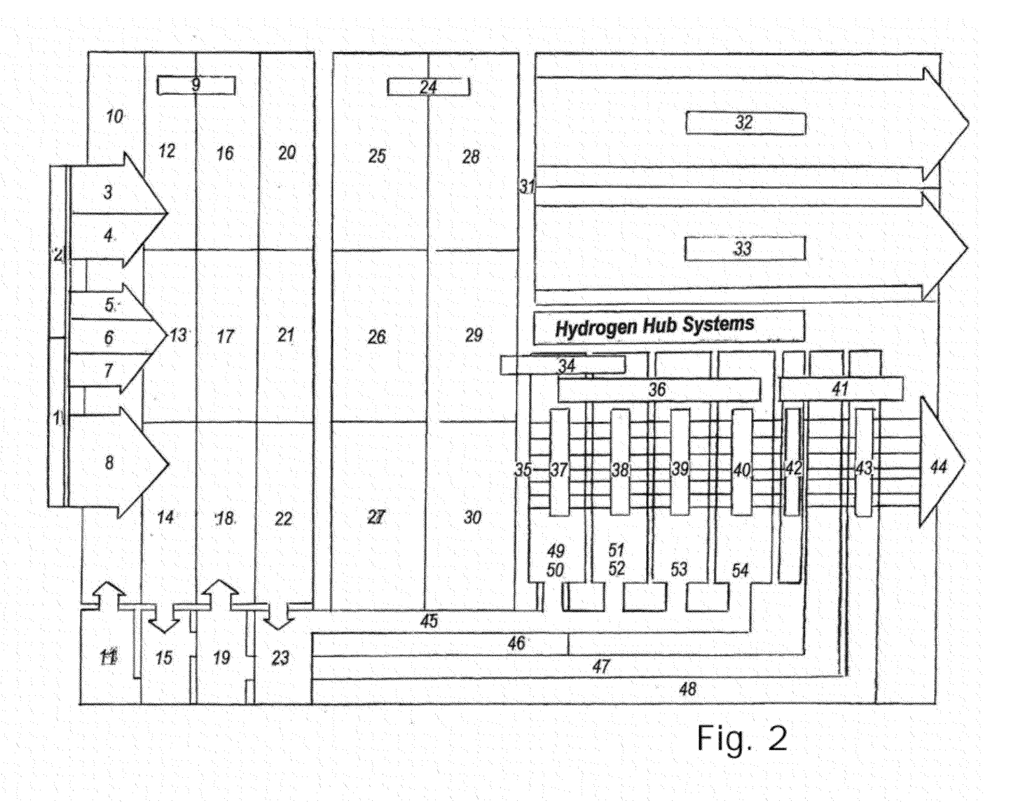

Hydrogen Hubs are a technological way to help manage the risk associated with intermittent, renewable and other energy sources. The development of a distributed Hydrogen Hub network across a specific geographic area of significant (terrestrial or high altitude) wind, solar, hydropower, wave, tidal or other renewable resources helps shape the uncertainty or intermittent natural resources in these areas. With Hydrogen Hub networks forming the technological basis for managing renewable energy risks across identified sub-geographies, unique Hub-based financial instruments and derivatives to manage renewable energy risks become viable. The result is a geographically specific, green ammonia derivatives market—a new tool to help manage energy and agricultural risk—enabled by the integrated Hydrogen Hub system shown in FIG. 2.

I. (2) Acquisition, Storage and Recovery of Hydrogen

The integration of a subsystem designed to acquire hydrogen through either the extraction of hydrogen by and through the electrolysis of water in an electrolysis-air separation Haber-Bosch process (see section I. 4.1 below), or from the reformation of water by and through an solid-state ammonia synthesis process (see section I.4.2 below), or by extraction of hydrogen gas from bio-mass of other hydrogen-rich compounds or from other sources (I. 4.3 below), or by the direct purchases of hydrogen from the open market, and/or through other methods or processes. Hydrogen can be stored in tanks on site.

I. (2.1) Hydrogen Injection System (HIS)

In a Hydrogen Hub designed to generate power from combustion turbines, the combustion turbine may require a mixture of some 80% ammonia and 20% pure hydrogen gas to operate at maximum efficiency (see section I.8.6 below). Therefore, before the hydrogen gas is absorbed into the electrolysis-air separation Haber-Bosch process described at section I.4.1 below, the HIS system diverts a portion of the hydrogen gas to the combustion fuel injection site under control of the Hub Green Meter Storage and Management system described at section I.4.6 below.

I. (3) Acquisition, Storage and Recovery of Nitrogen

The integration of a subsystem designed to acquire and store nitrogen through either the extraction of nitrogen from the atmosphere using air separation units, or the extraction of nitrogen from biomass and other nitrogen-rich compounds, the capture and recycling of nitrogen produced as emissions (along with water vapor) from the Hydrogen Hub power generation process, or by direct purchases of nitrogen from the open market, and/or through other methods or processes.

I. (3.1) Nitrogen Recovery System (NRS).

The NRS captures and recycles nitrogen gas back to the holding tank from generation emissions of anhydrous ammonia for potential storage and reuse in the Hydrogen Hub ammonia synthesis cycle, or for commercial sale. The NRS provides a “closed loop” environmental system wherein the nitrogen may be recovered, along with water vapor, from Hub generation emissions through a closed condensate-nitrogen separation process. This recovered nitrogen may be tanked and sold for commercial purposes or injected back into the nitrogen loop of the ammonia synthesis process, thereby potentially increasing the overall energy efficiency of Hydrogen Hub operations.

I. (4) Synthesis and/or Acquisition of Anhydrous Ammonia

The integration of a subsystem/s designed to synthesize hydrogen from water and nitrogen from the atmosphere into anhydrous ammonia or to purchase anhydrous ammonia from the open market. Ammonia synthesis and purchase options include:

I. (4.1) Electrolysis-Air Separation-Haber-Bosch (EAHB) Process.

First, hydrogen is extracted from water in the electrolysis-air separation Haber-Bosch process through the electrolysis of water using megawatt-scale electrolyzers available on the market today. The higher AC voltages from the power grid, or provided directly by wind turbines isolated from the power grid, are stepped down to the lower voltage, higher-amplitude or higher amperage DC power required by the electrolysis-air separation Haber-Bosch electrolysis process. It takes about 420 gallons of water to produce a metric ton of ammonia through electrolysis. The water can be nearly fully captured and recycled as water vapor from the Hub generation process (see 5.1 below).

Second, nitrogen is extracted from the atmosphere using an Air Separation Unit (ASU), again using existing technology.

Third, the hydrogen and nitrogen are then synthesized into NH3 using a market-available Haber-Bosch catalytic synthesis loop process in which nitrogen and hydrogen are fixed over an enriched iron catalyst to produce anhydrous ammonia. If the source of the power running the EAHB/ASU system is wind, solar, hydro or other renewable energy, green anhydrous ammonia is created. It is estimated that an electrolysis-air separation Haber-Bosch process consuming one megawatt of electricity would produce two tons of anhydrous ammonia per day, before any efficiency improvements. Hydrogen Hubs will recycle steam from the Hub generation process, super insulate core temperatures inside the synthesis process, and recycle nitrogen from generation emissions to create greater efficiencies within the electrolysis-air separation Haber-Bosch process.

I. (4.2) Solid State Ammonia Synthesis (SSAS) Process.

In the Solid State Ammonia Synthesis process, the higher AC voltages from the power grid—or provided directly by wind turbines isolated from the power grid—are again stepped down to the lower voltage, higher-amplitude or higher amperage DC power required by the solid-state ammonia synthesis process. With solid-state ammonia synthesis water is decomposed at an anode, hydrogen atoms are absorbed and stripped of electrons; the hydrogen is then conducted (as a proton) through a proton-conducting ceramic electrolytes; the protons emerge at a cathode and regain electrons, then react with absorbed, dissociated nitrogen atoms to form anhydrous ammonia. Solid-state ammonia synthesis is, as of this writing, at the design stage. Solid-state ammonia synthesis has the potential to significantly improve the efficiency and lower the cost, of ammonia synthesis compared to the electrolysis-air separation Haber-Bosch process. Again, if the source of the power running the solid-state ammonia synthesis system is wind, solar, hydro or other renewable energy, then “green” anhydrous ammonia is created. It is estimated that a solid-state ammonia synthesis system consuming one megawatt of electricity would produce 3.2 tons of anhydrous ammonia per day. Hubs would seek to improve the solid-state ammonia synthesis efficiency still further through recycling of heated steam and nitrogen from Hub generation emissions directly into the solid-state ammonia synthesis process.

I. (4.3) Hydrogen Acquired from Bio-Mass and Other Organic Compounds

In addition to hydrogen acquired from water as part of the ammonia synthesis processes described in I.4.2 and I.4.3 above, Hubs can also acquire hydrogen from operations to recover hydrogen gas from biomass and other organic sources and/or compounds. Hydrogen from these sources can be collected, stored and introduced directly into the Haber-Bosch process described above to create ammonia. This avoids the energy costs associated with the electrolysis of water. Trucks can transport portable Hub ammonia synthesis plants to key locations where hydrogen from biomass and other sources can be directly synthesized into ammonia.

I. (4.4) Core Thermal Maintenance System

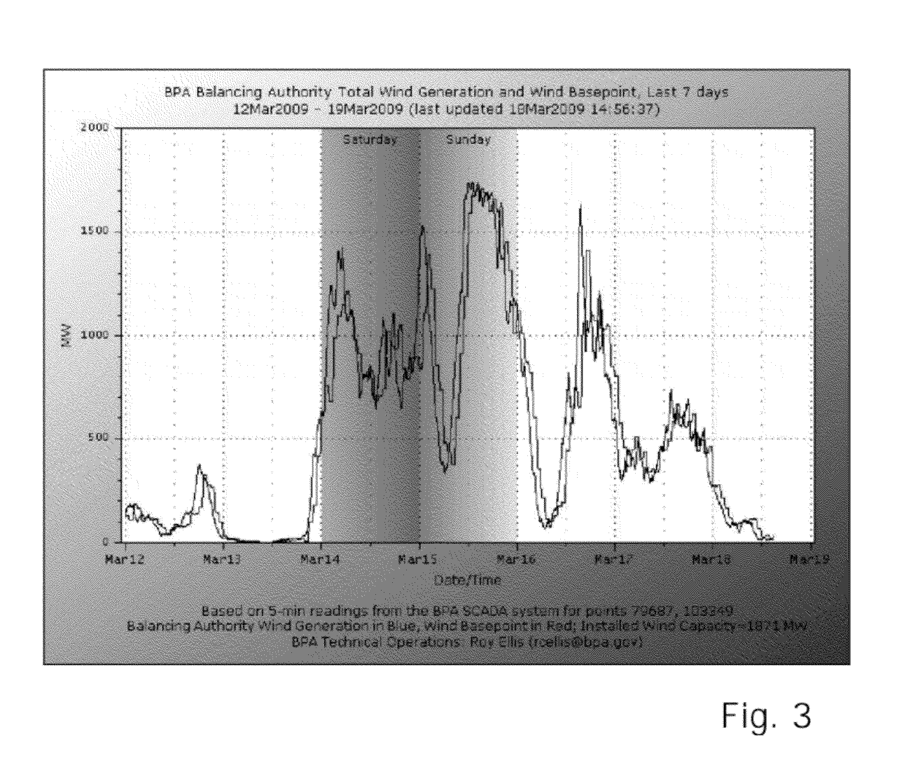

Hydrogen Hub ammonia synthesis operations can be designed to help solve one of the most serious problems facing utilities with increasing exposure to wind energy: wind ramp events. In one example, the Bonneville Power Administration recently recorded the ramping of some 1,500 megawatts from near zero to full output capacity within a half hour on Mar. 14, 2009, as shown in FIG. 3. Such significant ramping events pose serious problems for power grid stability. They create a tension between power system managers who may be biased to shut down wind production to stabilize the grid, and wind companies who benefit when turbines are operating as much as possible. This tension grows as tens of thousands of megawatts of additional wind farms are added to power systems in the coming years.

Hub ammonia synthesis operations can be designed to act as a valuable power “sink” to capture intermittent power resources, including wind ramping events, during periods of high or unpredictable generation. To achieve this, the thermal systems embedded in the electrolysis-air separation Haber-Bosch, solid-state ammonia synthesis and other synthesis processes must maintain temperatures and other operational characteristics sufficient to be able to “load follow” these and other demanding generation conditions.

The core thermal maintenance system will super-insulate the thermal cores and provide minimum energy requirements to the electrolysis-air separation Haber-Bosch and solid-state ammonia synthesis core systems. This will assure sufficient temperatures are maintained to be able to trigger on the ammonia synthesis processes within very short time durations. This will allow the solid-state ammonia synthesis, EHAB and other ammonia synthesis process to capture these rapidly emerging wind ramping events. These thermal efficiency improvements will be integrated to the real-time information gathering and predictive capabilities of Hub Power Sink (HPS) (see 1.2 above) to insure Hub synthesis technology is “warmed” to minimum operating conditions during periods when wind ramping conditions, for example, are predicted for the specific geographic location of the wind farm located in proximity to the Hydrogen Hub.

The goal is to use core thermal maintenance and HPS systems to help insure Hub synthesis operations some or all of these key services: 1) ongoing power regulation services sufficient to respond within a 2-4 second operational cycle; 2) load following services within 2-4 minutes of a system activation signal; 3) spinning reserves within 10 minutes of a system activation signal; 4) non-spinning reserves within 10-30 minutes of a system activation signal; and other load following values.

The HPS uses “smart” control systems to activate and shape Hub ammonia synthesis operations. HPS can turn the synthesis operation on or off in real time by remote control and under preset conditions agreed to by the Hub and power grid manager. Or HPS can shape down the synthesis load through the interruption of, for example, quartiles of synthesis operations at and among a network of Hubs under control of HPS within a designated control area. This allows maximum flexibility of Hubs to respond to unpredictable natural wind events across a dispersed set of wind farms within general proximity to one another while core thermal maintenance insures sufficiently high core temperatures to respond to these various load following demands.

I. (4.5) Interruptible Load

The HMS and HPS systems can also be used to automatically interrupt part or all of the Hub ammonia synthesis operations by preset signal from power grid managers under defined operational and price conditions. The ability to drop Hub synthesis load has great value during peak power emergency conditions, for example. This unique flexibility can also increase effective utility reserves.

At the same time, Hydrogen Hub on peak power generation can also be automatically triggered under HPS to help increase energy output during a pending emergency or when real-time prices trigger Hub generation output. Hydrogen Hubs uniquely combine these two important characteristics in a single, integrated technical solution. A 50-megawatt Hydrogen Hub can provide 100 megawatts of system flexibility by instantly shutting down 50 megawatts of its ammonia synthesis operation and simultaneously bringing on line 50 megawatt of on peak, potentially renewable energy within minutes. Few other energy resources can provide this virtually real-time, grid-smart integrated energy value.

I. (4.6) Hub-Enabled Blue/Green Ammonia Purchase and Exchange Agreements

There are a number of potential alternatives means to acquire anhydrous ammonia, including the purchase of “blue” (non-renewable) anhydrous ammonia from the open market. As described (in I.1.2, I.1.3 and I.1.4) above the HPT, HCB and GME systems together create the independently verified, transparent foundational data and tracking system for establishing a robust regional, national and international green ammonia trading exchange wherein green ammonia can be purchased, sold, exchanged or hedged, physically or by contract, between parties.

Hub ammonia purchase and exchange agreements, allow the tracking and exchanging of Hub-created green ammonia with blue ammonia from the open market across the world. This Hub-enabled market is particularly important given the potential for carbon cap and trade requirements. As mentioned earlier, anhydrous ammonia sold on the open market today is almost exclusively made through a steam methane reforming process powered by natural gas or coal. This 100 million ton per year global anhydrous ammonia market is therefore one of the world's largest single sources of carbon dioxide and other pollutants. “Blue” ammonia purchased from this market would not qualify as green or be eligible for renewable energy or carbon credits, for example. It may be subject to carbon taxes or other costs.

But, “blue” ammonia, purchased and used as fuel as Hydrogen Hub generation sites (see below) would nonetheless—like green ammonia—generate only water vapor and nitrogen emissions at the site of generation. It could therefore provide on peak power, like green ammonia fuel, without adding to local air pollution. Both green and blue anhydrous ammonia fuel could therefore power Hydrogen Hub generation sites, even during serious air quality episodes, with zero pollution. To the extent the Hydrogen Hub had to use non-renewable ammonia as a fuel source, that pro rata portion of the power generated by the Hub would not qualify as renewable energy. That portion of generation at the Hub that used green ammonia as a fuel could qualify as renewable. We propose a Green Meter Storage and Management System (below) to measure and help manage the fuel mix at the Hydrogen Hub.

Purchase agreements, and other commodity exchange contracts enabled by Hydrogen Hub identification and tracking systems can be shaped to provide supplemental blue ammonia fuel stocks when green ammonia production naturally diminishes due to predictable reductions in renewable energy on a seasonal basis. These agreements and other natural energy derivative contracts (see I.1.5 above) can also mitigate price risk and availability concerns for ammonia fuel in the event of emergencies, transportation disruptions, or other serious events. The Hydrogen Hub design allows for the use of both green and blue ammonia as a generation fuel while carefully tracking green ammonia from Hub sites and carefully metering (see below) the use of both green and blue fuels as they enter the ammonia-fueled power generators.

I. (4.7) Green Meter Storage and Management (GMS).

To create fail-safe systems for accurately tracking green ammonia production and power generation by the Hub, two integrated metering systems are proposed. The first is the Hub Power Track (HPT) described in (1.2) above—a subsystem designed to determine the nature of the energy resource powering the Hydrogen Hub ammonia synthesis-related technologies. The HPT determines in real-time what percentage of the synthesized ammonia produced and stored at the Hub came from renewable energy resources, or other, resources.

Green Meter Storage then makes a second calculation. The GMS measures the percentage of stored green and blue ammonia entering the ammonia-fueled power generation system. For example, assume there are two ammonia tanks at the Hub, one filled with carbon-based blue ammonia purchased in the marketplace. The other tank contains pure green ammonia. Or it may contain and HPT-defined green ammonia and non-green ammonia fuel mixture created on-site by the Hub. Let's assume the HPT has calculated earlier in the Hub synthesis process that the amount of green ammonia in the second tank constitutes 50% of the total.

Let's further assume the Hub managers determine they want the Hub generators to operate in a 25% renewable power condition. The GMS will automatically signal Hub system controls for ammonia fuel injection into the generators to insure an equal mix of ammonia fuel from both the “green” and “blue” tanks. GMS control electronics open valves from both tank sufficient to insure the renewable power objective. The 50% green ammonia fuel from the green tank will be diluted to 25% by the equal injection into the power generation system of ammonia fuel from the tank containing 100% blue ammonia and thus the power input of the Hub will match the 25% renewable power objective set by managers.

The HPT and GMS systems work together to determine the final green power output of the Hub at a given time. The data from these two integrated systems is designed to be managed by an independent firm, be transparent to regulatory and other authorities, be available in real time, supply constant, hard-data backup and be tamper-proof.

I. (5) Acquisition, Storage and Recycling of Water

A system to collect and store water in a holding tank for use as a hydrogen source for the EHB, solid-state ammonia synthesis, and other ammonia synthesis processes. About 420 gallons of water is used to make a ton of ammonia. One basic source of water comes from municipal and other local water supplies.

I. (5.1) The Water Vapor Recovery System (WVRS)

The WVRS is designed to capture water vapor from Hub generation emissions and recycle the water through a condensation and recovery system back into the Hydrogen Hub water holding tank, or directly into the Hydrogen Hub synthesis process. It is expected that the WVR will recover virtually all of the water converted to hydrogen in the ammonia synthesis process. The WVR forms a “closed loop’ environmental system where little net water is lost during Hydrogen Hub operations. The WVR is integrated with the Nitrogen Recovery System described at 3.1 above.

I. (6) ACQUISITION, STORAGE, AND GENERATION INJECTION OF OXYGEN. A system to collect, store and use oxygen at the Hydrogen Hub site created as a by-product of the EHB, solid-state ammonia synthesis, and potentially other ammonia synthesis processes using water as a source of hydrogen.

I. (6.1) The Hub Oxygen Injection System (OIS)

The OIS is a subsystem designed to divert the oxygen gas created during the electrolysis and solid-state ammonia synthesis processes for use for an energy efficiency boost in the NH3-fueled electric power generation systems. The OIS is electronically integrated with the Green Metering System and controls the injection of oxygen into the ammonia fuel combustion chambers. This enhances both the ability to ignite ammonia's relatively high combustion energy, and increases the overall energy efficiency of ammonia fueled generation an estimated 5-7 percent depending on conditions and the specific generator design.

I. (7) Ammonia Storage

Anhydrous ammonia synthesized at Hydrogen Hub sites or purchase from the commercial market will be stored on site. Tanks will vary inside depending on the megawatt size of the Hub generation system and the desire duration for power generation from the site. Peak power plants usually are required to run less than 10% of the year. Portable anhydrous ammonia tanks can range in size from under a thousand gallons to over 50,000 gallons in size. Large-scale stationary anhydrous ammonia tanks can hold tens of thousands of tons. There are 385 gallons per ton of anhydrous ammonia.

A 10-megawatt Hydrogen Hub operating for 100 continuous hours, for example, would require about 500 tons (200,000 gallons) of anhydrous ammonia. This amount of ammonia could be held in four, 50,000-gallon tanks, for example. Fewer tanks would be required if the Hydrogen Hub synthesis operation was continuously providing ammonia supply at the same time Hub power generation was operating.

The global safety track record in storing and transporting ammonia has been very good. Indeed, millions of tons of ammonia are handled every year in most urban areas without incident. Ammonia is currently stored extensively at power generation sites and used to remove sulfur oxide (SOx) and nitrogen oxide (NOx) from the exhaust of natural gas- and coal-fired thermal projects.

I. (7.1) Heat Exchange System (EHS)

The anhydrous ammonia will be withdrawn from the storage tanks for injection into the Hydrogen Hub ammonia generation system (see below) as pressurized gas at about 150 pounds per square inch, depending on prevailing ambient temperatures. During withdrawal, liquid anhydrous ammonia will be converted into vapor by waste heat provided from the generator. The EHS will take coolant from the generator and rout it to a heat exchanger installed on the ammonia storage tank to provide sufficient temperatures for efficient transfer of ammonia as pressurized gas from storage to Hydrogen Hub generators.

I. (7.2) Hub Ultra Safe Storage and Operations (HUSO)

While the overall safety record of the anhydrous ammonia industry is good, NH3 can be a serious human health risk if ammonia gas is accidentally released and inhaled. Because Hubs will operate in industrial locations and elsewhere near urban areas, we proposed the option of the integrated HUSO system to all Hub operations. HUSS will incorporate options such as double-shell tanks with chemical neutralizers, protective buildings equipped with automatic water-suppression systems (large amounts of ammonia are easily absorbed by relatively small amounts of water) automatically triggered by ammonia-sensors, fail-safe connectors, and next generation ammonia tanks, fittings, and tubing to insure ultra-safe Hydrogen Hub operations.

I. (8) Hydrogen HUB Electric Power Generation

Anhydrous ammonia is a flexible, non-polluting fuel. In the past NH3 has powered everything from diesel engines in city buses, to spark-ignited engines, to experimental combustion turbines, to the X-15 aircraft as it first broke the sound barrier. A ton of anhydrous ammonia contains the British Thermal Unit (BTU) equivalent of about 150 gallons of diesel fuel.

Hydrogen Hubs will take full advantage of this flexibility. Anhydrous ammonia made by Hydrogen Hubs or purchased from the open market can power many alternative energy systems. These systems include modified diesel-type electric generators, modified spark-ignited internal combustion engines, modified combustion turbines, fuel cells designed to operated on pure hydrogen deconstructed from ammonia, new, high-efficiency (50%+), high-compression engines designed to run on pure ammonia, or other power sources that operate with NH3 as a fuel.

In addition, Hub generation also can run on a fuel mixture of pure anhydrous ammonia plus a small (+/−5%) percentage of bio-diesel, pure hydrogen or other fuels to effectively decrease the combustion ignition temperature and increase the operational efficiency of anhydrous ammonia.

Pass-Through Efficiency

Hydrogen Hubs make their own fuel. They then use the fuel to generate power, or to sell anhydrous ammonia as fertilizer for agriculture, or for other purposes. But in the power production mode, the total pass-through efficiency for Hydrogen Hubs range from roughly from 20% to over 40%, depending on the efficiencies of the ammonia synthesis and power generation technology chosen. Existing electrolysis-air separation Haber-Bosch technology and power generators will result in pass-through efficiencies at the lower end of the range. New ammonia synthesis technologies such as solid-state ammonia synthesis combined with high-efficiency power generators will increase overall efficiency to the top end of the range—and possibly beyond.

A comparison of Hydrogen Hub pass-through efficiencies with power generator by natural gas is instructive. Comparable natural gas generation would start with the efficiency of the generator. This would be roughly comparable to the efficiency of the same generator modified to run on ammonia.

But overall natural gas pass-through efficiency would need to also include energy efficiency deductions for energy lost in locating the gas field, building roads to the site, preparing the site, drilling and capturing the natural gas from underground wells, transporting the gas to the surface, compressing the gas for transport, building the gas pipeline and distribution systems, somehow capturing CO2 to create a level playing field, and then, finally, using the gas to power the combustion turbine. If all these elements are taken into account, Hydrogen Hub pass-through efficiencies are comparable. This does include the Hub environmental and location benefits associated with the use of a carbon-free fuel.

An efficient Hydrogen Hub, for example, can convert hundreds of thousands of megawatt hours of off-peak spring Northwest hydropower, wind and solar electricity priced (in 2008) from a negative two cents a kilowatt-hour to plus two cents a kilowatt-hour into on peak power. The on peak pass-through prices could range between less than zero cents a kilowatt-hour to under ten cents a kilowatt hour depending on the Hub technology in place at the time. The power would be deliver by Hub generation sites at the center of load with zero pollution.

By comparison, West coast peak energy prices in the past five years ranged between some eight cents a kilowatt-hour to thirty cents a kilowatt-hour, according to the Federal Energy Regulatory Agency (FERC). During the west coast power emergencies at the turn of this century, peak prices escalated rapidly at times to over one hundred cents a kilowatt-hour and more.

FERC indicates peak power demand is one of the most serious challenges facing utilities nationwide—and elsewhere around the world. Meeting peak power demand is a major reason utilities commit to new, large-scale, at distance, carbon-burning power plants. By contrast, Hubs are designed to shave system peaks by placing non-polluting generation sources at the center of the source of demand.

The pass-through prices identified above do not include capital and other costs. But they also do not include a joint agriculture/energy capital program that can reduce these costs, potential BETC credits in Oregon, potential carbon credits, potential to create a strong, distributed network of generation sites inside urban areas to respond to load, resulting savings in transmission costs and congestions fees, potential savings in distribution system cost such as substations an new poles and wires to bring at-distance power generation to the center of load, or the fact that Hub generation may qualify to meet renewable energy portfolio standards, and other benefits.

These dominantly ammonia fueled generators can range in sizes and respond to a number of unique power requirements including large-scale power generators and/or generation “farms” designed to support the power grid, irrigation pumping, home and neighborhood power supplies, and many other purposes.

There are at least five major generation alternatives for Hydrogen Hub power generation.

I. (8.1) Converted Ammonia-Fueled Diesel-Type Generators

A key early element of Hydrogen Hub power generation will be the conversion of existing diesel-type engines to run on ammonia. This large fleet of existing diesel fired generators on the market today. These generators, often purchased for use at distributed locations for backup power in event of emergencies, have been little used due to strict limits on carbon-related emissions in urban areas. Severe air shed restrictions have can effectively limited or prohibited diesel-fueled generators—particularly during periods of severe air quality alerts when demand for peak power often escalates.

Often used diesel generators have only been operated for a short period of time—if at all. Their value has already been deeply discounted by the marketplace. As a result, these highly dependable, formerly polluting, diesel generators can be converted into Hub electric generation systems running on green ammonia from renewable power sources, with zero pollution, at a fraction of the cost of new purchasing new power generators. This has the potential of saving consumers tens of millions of dollars.

New generation systems may cost between $1.5 million and $2 million a megawatt. Hydrogen Hubs can convert existing diesel generators typically ranging in size from 35 kilowatts to five megawatts in size into clean, distributed electric power generators at the center of load. At the time of this patent application, the estimated cost for purchase and conversion of used generators is less than $500,000 per megawatt.

Converted diesel-type fuel systems will be redesigned to be free of any copper and/or brass elements that may come in direct contact with the ammonia fuel. This is due to anhydrous ammonia's capacity to degrade these elements over time. These elements will be replaced with similar elements typically using steel or other materials unaffected by exposure to NH3.

Anhydrous ammonia has a relatively high combustion temperature. This can be overcome by three separate methods in diesel-type generators.

I. (8.2) Converted Spark-Ignited, Ammonia Fueled Diesel-Type Generators. The first method is to retrofit the former diesel-fueled system to allow for spark-ignition of the ammonia in the combustion chamber. The resulting system creates a spark sized to exceed pure anhydrous ammonia's ignition temperature and allows for efficient operation of the Hub generators.

I. (8.3) Converted Spark-Ignited, Ammonia/Oxygen Fueled Diesel Generators. In the second method, the energy efficiency of Hub generation can increase if the ammonia fuel is combined with oxygen gas in the refurbished generator and injected in under controlled conditions and in pre-determined ratios by the Hub Oxygen Injection System (described at 6.1 above). Oxygen injection into the ammonia combustion process by HOIS is expected to increase the energy efficiency of ammonia-fueled diesel-type engines by an estimated 3-7%.

I. (8.4) Converted Ammonia/Oxygen/Hexadecane Fueled Diesel Generators. The third method does not require spark ignition into initiate ammonia combustion. In this method a small amount of high-hexadecane fuel, such as carbon-neutral bio-diesel fuel (or similar), is added to the anhydrous ammonia at a roughly 5% to 95% ratio.

During operation, as described by experiments conducted at the Iowa Energy Center, vapor ammonia is inducted into the engine intake manifold and (in this case normal) diesel fuel is injected into the cylinder to initiate ammonia combustion. The ammonia-bio-fuel mixture herein proposed will allow for efficient combustion of the ammonia without spark ignition and yet maintain the carbon-neutral characteristics of Hub generation. Care needs to be taken to use Hub control electronics to synchronize the continuous induction of vapor ammonia with the transient nature of the engine cycle in order to increase operating efficiencies and insure clean emissions.

This alternative will require the integration of a bio-fuels tank at the Hub location. It will also require the mixture of 5% bio-fuel with both green and blue ammonia from the Hub site. The Green Meter and Storage System (described at 4.6 above) can help control this mixture, insuring proper overall fuel balance and reporting during operations. The ammonia/hexadecane blend can be separately identified and tracked against green and blue ammonia sources by the GMS.

As with spark-ignited diesel-type generators, the HOIS system can increase the energy efficiency of non-spark generators by an estimated 3-7% by managing the injection of oxygen into the generating process during operation.

I. (8.5) New High-Efficiency, High Compression Ammonia Engines

New spark ignited internal combustion engines are being designed to run on pure ammonia and with increased compression ratios exceed 50% energy efficiency during the Hub power generation process. These generators may also be able to run on a mixture of ammonia and hydrogen, or ammonia and other fuels if necessary. The efficiency may be further increased at the Hub do to HOIS and other Hub system designs.

I. (8.6) Combustion Turbines

During the 1960s the U.S. Department of Defense tested a combustion turbine designed to run on ammonia. As with diesel and spark-ignited ammonia fueled engines, the keys to efficient operation of combustion turbines on ammonia fuel are to insure the ammonia does not come in contact with any copper or brass parts, and can that the Hub electronic control systems can manage the optimum injection of fuel into the turbine's combustion system.

In the case of combustion turbines, preliminary technical indications imply that prior to injection the anhydrous ammonia may need to be partly deconstructed into hydrogen gas to allow a mixture of 80% pure ammonia fuel with 20% pure hydrogen gas for optimum combustion turbine efficiency. This can be accomplished through the Hub Hydrogen Injection System (HIS) described in section 2.1 above. With the HIS, a portion of the hydrogen gas produced by the ammonia synthesis process described in sections 4.1 and 4.2 above can be diverted and managed by the GMS directly toward use in the combustion turbine fuel ignition process. In the alternative, hydrogen can be acquired from commercial sources and stored in tanks at the Hub generation site.

Combustion turbines bring a wide scale to Hydrogen Hub generation sites. This scale ranges from less than one megawatt-sized micro-turbines designed to power a home, office or farm, to 100+ megawatt sized Hydrogen Hub generation sites scaled up and distributed to key locations on the power grid to help meet the peak power needs of cities and other centers of electric load. Combustion turbines are an important element of the ability of Hydrogen Hubs to respond to scaled-up and scaled-down energy demands throughout the world.

I. (8.7) Ammonia-Powered Fuel Cells

Fuel cells have been developed with high cracking efficiency that can deconstruct anhydrous ammonia into hydrogen and nitrogen to power fuel cells. Fuels cells can be greater than 60% efficient and, combined with ultra-safe ammonia storage systems, will increase the pass-through efficiency of Hubs scaled to meet the backup energy needs of homes, offices, and small farms—and cars (see below).

I. (8.8) Portable Hydrogen Hubs

Self-contained Hydrogen Hubs modules can be sized within standard steel cargo containers. These contains can then be put on pre-configured pallets, and transported by trucks, trains, barges, ship, or other specifically-vehicles to create portable Hydrogen Hubs. These portable, fully integrated Hubs including system controls, ammonia synthesis, ammonia storage, and ammonia generation technologies sized to fit in the container and moved rapidly to the point of use. In the alternative, the self-contained module can contain a Hub power generation system only—with ammonia storage and other features permanently pre-positioned at key locations on the power grid. These portable Hubs—ranging from fully integrated to generation only systems depending on utility need—can provide generation backup in the case of emergencies other contingencies.

I. (9) Emissions Monitoring, Capture and Recycling (EMCC)

Hydrogen Hubs employ an integrated Emissions Monitoring, Capture and Recycling system to monitor, capture and recycle valuable emissions from ammonia-fueled electric power generation. There are four fundamental elements in overall EMCC system:

Nitrogen Recovery System

The NRS is described in section 3.1 above. NRS captures and recycles nitrogen gas back to the holding tank from generation emissions of anhydrous ammonia for potential storage and reuse in the Hydrogen Hub ammonia synthesis cycle, or for commercial sale.

Water Vapor Recovery System

The WVRS is described at 5.1 above. WVRS is designed to capture water vapor from Hub generation emissions and recycle the water through recovery tubes back into the Hydrogen Hub ammonia synthesis process or into a water holding tank. It is expected that the WVR will recover virtually all of the water converted to hydrogen in the ammonia synthesis process. The WVR forms a “closed loop' environmental system where little net water is lost during Hydrogen Hub operations.

Three other systems are also included in EMCC

I. (9.1) Hub Emissions Monitoring (HEM)

EMCC constantly monitors and provides real-time reporting data on air emissions from Hub generators. If pure anhydrous ammonia is used as a fuel, ECON should continuously verify Hub generation emissions are only water vapor and nitrogen.

As mentioned above, under certain circumstances it is possible for Hub operators to choose to inject a small percentage (estimated at 5%) of other fuels like bio-diesel into Hub combustion systems to help ignite ammonia combustion in non-spark ignited diesel-type generators. In this case, the EMCC sensors will accurately assess the relative level of all emissions produced as a result of mixing ammonia with another fuel source and provide real-time data to managers.

I. (9.2) Nitrogen Oxide Control (NOC)

Hydrogen Hub power generators may occasionally produce internal heat under specific circumstances to drive endothermic reactions between nitrogen and oxygen high enough to produce a small amount of nitrogen oxide (NOx) emissions. As Hub operational conditions threaten the formation of NOx, the EMCC system can alert Hub operators. NOC can then eliminate any residual nitrogen oxide emissions by spraying the emissions with on-site ammonia—used throughout the power industry as NOx cleansing agent.

I. (9.3) Thermal Water Recovery (TWR)

If the solid-state ammonia synthesis ammonia synthesis process is used, TWR offers the option of capturing hot water vapor emissions from Hub generation and re-introducing the vapor into the solid-state ammonia synthesis system. This can increase the operating efficiency of the solid-state ammonia synthesis thermal core and therefore overall Hub pass-through efficiencies.

II. LAND-BASED, DISAGGREGATED HUBS FULLY CONNECTED TO THE POWER GRID. In this configuration, the two most basic processes within Hydrogen Hubs—ammonia synthesis and power generation—are designed, built and sited at separate locations. Each location is connected to the power grid. The objective is to create ammonia and generate power at large scale with the greatest possibility overall efficiency.

Disaggregated Hubs can help capture the maximum value each process can provide to the power system—and to other industries as well. This value grows as the network of ammonia synthesis Hubs expands in rural areas to better capture wind and solar energy and as Hub power generation locations separately expand throughout cities and other centers of growing peak power demands. Both of these expansions help strengthen the power grid. Ammonia synthesis captures and shapes renewable energy at the source helping the grid manage increasingly large-scale intermittent resources. Hub zero-pollution power generation creates generation at the center of load that looks like demand response—helping the grid manage peak power demand.

Disaggregated Hubs can be scaled precisely respond to these challenges. They can be rapidly deployed to key locations on both ends—the power production and power consumption sides—of the energy equation. Separated Hub ammonia synthesis and power production can be scaled up at hundreds of separate sites, each operating at peak efficiency to meet the specific needs of the power grid at that location.

This increases the value of renewable energy, strengthens the power grid and diminishes the need to deploy billions of dollars to expand distribution and transmission systems to bring distance, isolated energy resources to market. Disaggregated Hubs can help stabilize costs for energy consumers. But they also can help lower the costs of ammonia produced for agricultural fertilizer, as a fuel for car and truck transportation fuel, and for other purposes.

Separate Hydrogen Hub ammonia synthesis plants can be designed to use the system controls, alternative synthesis technologies, and ammonia storage alternatives discussed in (I) above. These Hub synthesis sites can be located in rural areas near large-scale wind farms with access to roads, train tracks or water transportation. The Hub synthesis system can be located between the wind farm and the integrating point for energy from the wind farm into the power grid.

II. (1) HUB-ENABLED ENERGY-AGRICULTURE EXCHANGE AGREEMENTS. Large-scale disaggregated Hubs, scaled up to hundreds of megawatts, offer unique opportunities to maximize the value of Hubs to both the energy and agriculture industry. This in turn allows for capital sharing and price arrangements that cannot be matched by other energy technologies. A Hydrogen Hub energy-agriculture exchange agreement can dramatically reduces prices to both industries.

An operational example of an energy-agriculture exchange arrangement may help. In the vicinity of Umatilla, Oregon, for example, energy from large scale wind farms located at the east end of the Columbia River Gorge provide power to the grid. This power blows heavily during the spring, when hydro conditions already create hundreds of thousands megawatt hours of electricity that we excess to the needs of the Pacific Northwest. These new wind farms add to this surplus, renewable power condition, causing prices to range from minus two cents to plus to cents a kilowatt hour.

Let's assume an initial 100-megawatt Hydrogen Hub ammonia synthesis plant is located between these wind farms and the high voltage power grid operated by the Bonneville Power Administration. Let's further assume the synthesis plant is located at the Port of Umatilla on the Columbia River, a port that has access to ocean-going barges and other vessels that transport ammonia by water. Umatilla is surrounded by one of the most agriculture intense regions of the Northwest. There is a heavy demand for ammonia as a fertilizer throughout the area and on into eastern Oregon and Washington.

The fundamental elements of the Hydrogen Hub-enabled, Energy-Agricultural Exchange Agreement are a power/commodity exchange between the grid operator and ammonia synthesis operations. The Agreement would allow both industries to share the capital and operating costs of Hydrogen Hubs, reducing overall costs to both industries. Hydrogen Hub technologies create new operating flexibility that can benefit both sides.

Energy Values

For the energy interests, the agreement: (1) will allow the grid operator to control, reduce or interrupt the ammonia synthesis load when the grid faces peak energy demands or other interruptible conditions defined under contract—power grid conditions that typically do not occur more than 5% of the year; (2) will allow the grid operator to shape and manage high generation conditions that may threaten grid stability by diverting high wind output directly into Hub ammonia synthesis operations located adjacent to the wind farm and away from the power grid; (3) will allow the energy interests to own ammonia synthesized during the conditions described in (2) above, and also during defined periods (typically less than 10% of the year) when high generation output may significantly reduce the value of energy produced by wind and other sources; and (4) will allow the energy interests use this ammonia to fuel on peak power at Hub generations sites near the center of load.

The energy in the ammonia produced in a single day of from a 100-megawatt Hub synthesis plant would range between the equivalent of 30,000-48,000 gallons of diesel fuel, depending on whether electrolysis-air separation Haber-Bosch or solid-state ammonia synthesis processes were used. But unlike diesel fuel, the non-carbon ammonia would produce zero emissions as it fueled Hub generation sites near the center of load.

Agriculture Values

In exchange for provide these unique load and generation benefits to energy interests, the agriculture interests would be allowed a reduced power rate for the Hub ammonia synthesis operations during the balance (estimated at 90% depending on contract conditions) of the operating year. Agriculture would own the ammonia produced during this period. This price reduction would be designed to insure that ammonia produced by the plant would remain competitive with ammonia produced from carbon sources throughout the world. As mentioned, a significant percentage of this ammonia in the Northwest would be from renewable sources and potentially qualify for carbon credits and other benefits.

The basic elements of a Hub-Enabled Energy-Agriculture Exchange Agreement would include:

II. (1.1) Basic Power Contract

The 100-megawat Hub ammonia synthesis operation runs year-round at the Umatilla site from power purchased from the Bonneville Power Administration. Energy from Bonneville's system is from over 85% non-carbon sources, including hydropower, wind, solar, and nuclear energy. When normal conditions prevailed, the Hub synthesis operation would operate at full high capacity taking power directly from the grid. With power prices at 5 cents a kilowatt-hour, ammonia can be produced for estimated $500-900 a ton, depending on the synthesis technology chosen. Normal ammonia prices ranged between $550-$1,200 a ton in the Northwest in 2008.

II. (1.2) Guaranteed Ammonia Price

Agriculture interests in the region agree to purchase ammonia from the Hub site for a guaranteed price of $700 a ton plus inflation over a contract period of, for example, ten years. This price does not reflect the carbon benefits of producing green ammonia from renewable power sources. The ammonia is transported to existing ammonia storage locations already used agriculture. The $700+ a ton price pays for the capital and operational costs of the ammonia synthesis operations.

II. (1.3) Reduced Cost Power Contract

The power grid operator agrees to provide a discounted power rate below the 5-cent basic price. In exchange, agriculture interests allow a portion or all of the Hub ammonia synthesis operation to be interrupted during high periods of high wind conditions and during limited peak power periods, as described above. These periods are limited by contract to, for example, ten percent of the operating year.

(II.1.4) Wind Farm Interruption Agreements

During high wind periods, the Hub synthesis operation may be automatically disconnect from the power grid by authority of the grid operator under the contract. In this situation, the Hub will instead be powered dominantly or exclusively by wind energy from the nearby wind farms. Some or all of the wind power, including power from wind ramping events, is diverted directly into the Hub synthesis operation. This helps stabilize the power grid. It also diverts wind energy that will be sold at very low values (−2 cents to +2 cents a kilowatt hour in 2008) into the creation of highly valuable green ammonia fuel for later use on peak at Hydrogen Hub generation sites at the center of load.

(II.1.5) Water Transportation Agreement

Standard ammonia barges containing large-scale ammonia tanks pull up to the Umatilla Hub synthesis site next to the Columbia River. Under the Agreement, green ammonia produced during this period is controlled by the energy interest.

The synthesis of wind energy, water and air produces green ammonia that is transferred by pressurized pipes into these barges. The barge moves the ammonia downstream to Hydrogen Hub generation locations on the Columbia River near Portland, Oregon and Vancouver, Washington. These sites are designed to allow the barge to connect dock at the site. The green ammonia can also be transported via truck or train to the Hub generation site if water transportation alternatives are not available.

The barge then pumps the green ammonia fuel into the Hub generators for on peak, zero-emissions renewable energy at the source of load. The Hub generation site is chosen for proximity to the Columbia River and to take advantage of existing substation and other distribution facilities from a previously abandoned or underutilized industrial operation. The Hub turns this location into a green energy farm.

II. (1.6) Peak Power Interruption Contract

Under a peak power interruption agreement, the agriculture interests agree to allow Hub operations to be interrupted—in part or in whole—during peak summer or winter power conditions.

At the same time, the power grid can signal Hydrogen Hub generation systems located at the center of load to turn on. The simultaneous reduction of 100 megawatts of ammonia synthesis load, and the increase of 100 megawatts of peak power from Hydrogen Hub generation sites at the center of load creates a 200-megawatt INC—all controlled in real-time under pre-specified conditions by the power grid operators under the Agreement.

Under this Energy-Agriculture Exchange Agreement both parties benefit along with energy and food consumers.

Agriculture interests get a new source of ammonia—a crucial ingredient to global food production—produced from local power sources from potentially all “organic” sources—renewable electricity, water and air. The long-term price is competitive. They reduce their dependence on foreign sources of fertilizer made by carbon-based energy sources, subject to uncertain carbon taxes, and potential supply disruptions. The benefits paid them by the power interests are vital and it creates a power sales price that makes the cost of the locally produced ammonia competitive over time. As a result, the agriculture interests effectively pay for the capital and operating costs of the Hydrogen Hub ammonia synthesis operation.

In exchange, the power interests to the agreement would realize at least four major benefits: 1) access to a non-polluting, hydrogen-dense, potentially renewable fuel at very reasonable prices; 2) on-peak, zero-emission power generation near the center of load; 3) a load that can act as an on-demand “sink” for intermittent wind and solar energy, and wind ramping events; 4) a load that can be partly or fully interrupted during extreme on peak conditions or when a power emergency occurs; and 5) long-term stabilization of the power grid.

Peak prices could be very competitive particularly if the Hub green ammonia fuel were created with electric energy at or below two cents a kilowatt-hour. Moreover, it is estimated that diesel-type engines can be converted to run on ammonia for some $500,000 per megawatt. The price per megawatt of new wind or other new generation resources in 2008, for example, ranged between $1.5 million and $2 million per megawatt.

As described in above, the Hub Power Track system (I. (1.2 above) would monitor the flow of electrons from specific sources in real time, providing a “green” profile for the ammonia being produced by electricity from these sources. As wind events approached threatening to destabilize the power grid, the Hub Power Sink system (I. (1.1) above) would signal the Hub to turn off ongoing ammonia production to create a stand-by reserve. Other Hub “smart” electronic control systems could also employed in a disaggregated Hub configuration.

III. LAND-BASED, DISAGGREGATED HUBS PARTIALLY CONNECTED TO THE POWER GRID. The primary purpose of this Hydrogen Hub configuration is to capture wind solar and other sources of renewable energy isolated from the power grid.

Capturing Large-Scale Isolated Renewable Energy

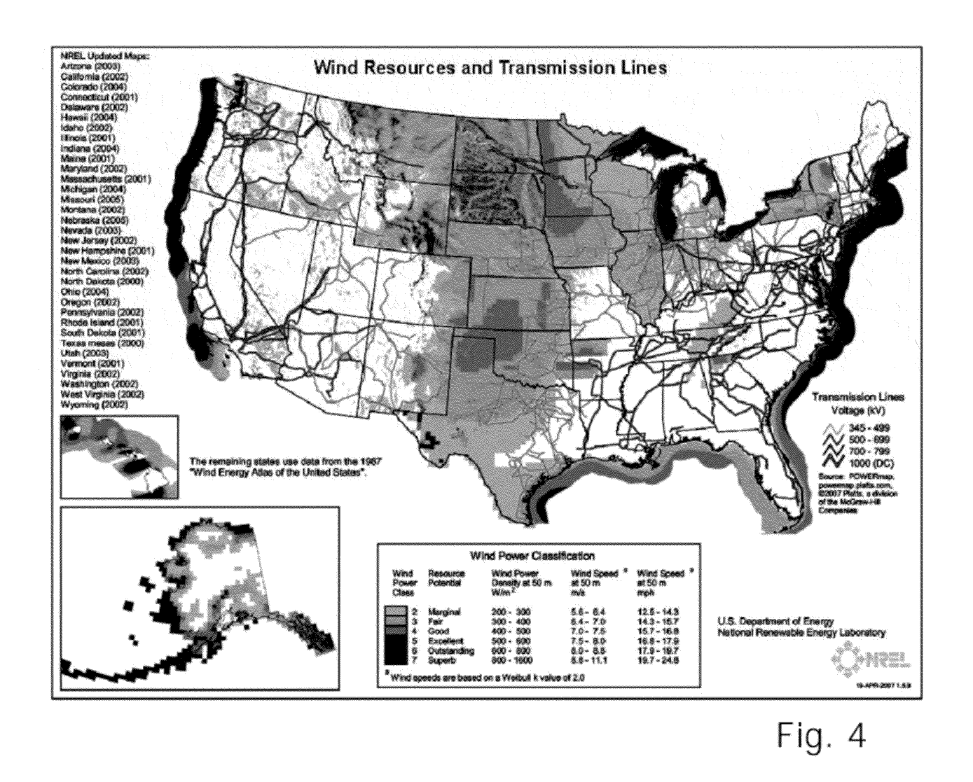

As FIG. 4 indicates, in the United States alone there are tens of thousands of megawatts of high-value (Class 4-7) wind sites that are not now connected to the power grid due to capital costs, construction delays, or outright prohibition of large-scale transmission construction across environmentally sensitive areas. Add to this potentially tens of thousands of additional megawatts of solar energy that is isolated from the power grid for similar reasons.

Beyond terrestrial-based wind and solar resources, there are new, proposed high altitude wind generators (HAWG) that may also prove of great value to the renewable energy future of the both the U.S. and global markets. HAWGs are typically configured in a constellation of four 1-10 megawatt wind turbines connected by a light composite structural platform. The platform of connected turbines is designed to fly itself into the jet stream, some 15,000-30,000 feet above the earth. At these altitudes, the winds in the jet stream, particularly between 40-60 degrees latitude in both the northern and southern hemispheres, blow at year-round capacities approaching 90 percent. Some estimates indicate that, due to the relatively low cost of HAWGS and high capacity of jet stream winds, the costs of power from this new alternative may average five cents a kilowatt hour or less.

Once they capture the wind energy in the jet stream, the high altitude generators move into an auto-rotation cycle, generating net electric energy. The energy is then sent back to platforms on through Teflon-type coated, aluminum cables. If this sub-space wind energy can be tapped it could potentially provide base-load type renewable power. Jet stream energy could be integrated with terrestrial wind and solar energy across a wide range of geographic locations.

Scientists have estimated that capturing jet stream winds in one percent of the atmosphere above the United States could power the entire electric needs of the country. The HAWG technology is maturing quickly. As of this writing, a two thousand megawatt high altitude wind generation site as been proposed for an isolated ranch in central Oregon. The first prototype HAWG can be constructed and tested in the jet stream within two years, according to its inventors. HAWG energy is important because it can help provide relatively constant power to Hub synthesis operations, supplemented by terrestrial wind and solar power. This allows maximum operational efficiency and keeps the ammonia synthesis thermal core systems at optimum temperatures.

Hydrogen Hub ammonia synthesis plants can capture isolated terrestrial wind and solar energy, and high altitude wind generation, in the form of green ammonia. Hubs then offer an alternative to the electric transmission of energy to load. Hubs store and deliver this energy in the form of green ammonia to Hydrogen Hub generation sites or to other markets by truck, train and/or pipeline. Hubs form a second option spending potentially billions of dollars, and many decades, on the integration of these isolated renewable sites with high voltage transmission systems. Hubs can save time, money and minimize environmental impacts capturing these resources. Hub plants can be precisely sized to meet the energy output of the renewable resource site—and can grow if the size of the site increases. Ammonia synthesis and transportation can also complement—not just compete with—standard energy transmission alternatives depending on geographic and other circumstances.

Water Sources and Recycling

The isolated Hub green ammonia synthesis sites will require groundwater sources, and on-site water storage, sufficient to meet the requirement for hydrogen in the synthesis process.

If net consumption of water is an issue in the locality, water can be brought back to the isolated site by the same trucks that carried the green ammonia out. The returning water can come from recycled emissions from the Hydrogen Hub generation sites as described in (I) above. The water recovered from emissions is returned to the Hub synthesis site and stored in water tanks for future use. The same trucks that transported the ammonia to market can bring the water back in their empty tanks. The water can be reused in ammonia synthesis at the site, causing little net loss of local water resources.

III. (1) Hub Water Exchange Market (WEM)

In the alternative, a Hydrogen Hub water exchange market can be established. The Hub Emissions Monitoring system (9.1 above) can be used to track the water resource recovered through emissions at the Hub generation site. Rather than expending the energy required to bring back a full tank of water to the isolated site, the water recovered and captured at the Hub generation location can be used to create a water credit.

The credit can be applied to the municipality, for example, closest to the isolated Hub synthesis site. Trucks with empty tanks can stop at the municipality on the way back to the Hub synthesis site. The municipality should receive a value mark-up for the water used, reflecting the net energy saved in not having to transport the water the entire distance back from the Hub generation location.

IV. LAND-BASED, INTEGRATED HUBS OPERATING INDEPENDENTLY FROM THE POWER GRID. Over a billion people in the world have no access to electricity, clean water or fertilizer to grow crops. A small-scale (typically less than one megawatt) Hydrogen Hub is designed help provide these essential commodities to the developing world.

Wind Light Hubs

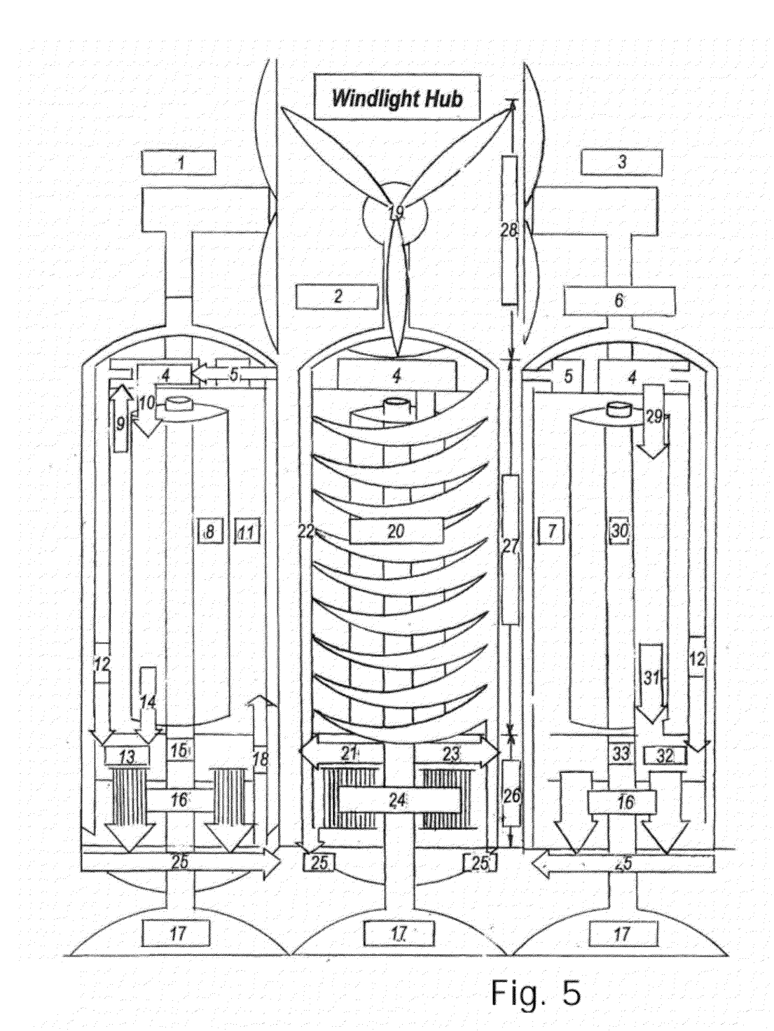

This smaller, fully integrated system, operating entirely independently from the power grid, is referred to in this invention as a Wind Light Hub. FIG. 5 is one embodiment of a Wind Light Hub according to the present disclosure.

Optimum locations for Wind Light Hubs are those near existing villages and towns with available ground water, or groundwater that than can be tapped by a well. The local geography must also have significant terrestrial wind and solar energy resources to power the Hub. Depending on its latitude in the northern or southern hemisphere, the Hub may also be connected to power from a high altitude wind generator (HAWG) as described in (III) above.

Land-based hubs, referred to here as Wind-Light Hubs, operating completely independent from the power grid in smaller, isolated communities worldwide. In this configuration Hub functions are integrated into a singular design that captures intermittent wind and solar energy, water and air and turns these resources into predictable electricity, renewable ammonia, and clean water for villages and communities with little or no access to these essential commodities.

IV. 1 Wind Light Tower

A Wind Light Tower looks from a distance like a standard one-megawatt wind turbine. But the base of the Wind Light Hub is thicker, allowing it to contain an anhydrous ammonia storage tank, a water tank, green ammonia synthesis technology, and two ammonia-fueled power generators.

As shown in FIG. 5, the Wind Light Hub may include three modules in an embodiment configured to be delivered to a village site in three modules. The three modules are each sized to be delivered to the site on trucks and rapidly assembled. Prior to the construction, a well is dug at the site to verify ongoing access to water. The site is also chosen for potential access to high-capacity jet stream wind, and to terrestrial wind energy and solar energy as well.

As seen in FIG. 5, there may be three module elements to the Wind Light Tower. A truck or helicopter can transport each of these three elements to the site where they will be structurally integrated on location.

IV. (1.1) Wind Light Tower—Module 1

Module one forms the foundation of the Wind Light Tower. This module houses the ammonia-fueled power generation system.

These generators are chosen for their durability and may include new high-efficiency internal combustion or diesel engines designed to run on pure ammonia. The module will contain induction valves controlling the flow of ammonia into the combustion chambers. Oxygen gas from the ammonia synthesis operation in Module II is injected into the combustion chamber. Water vapor emissions from the generator are captured and recycled into the water tank in Module II. Nitrogen gas from the ammonia synthesis process can be recycled into the synthesis operation or vented back into the air.

The generators are turned on by electronic controls under preset conditions determined by the light, heat or refrigeration needs of the village, or by manual control overrides. The power is distributed to the village by way of underground cable or above ground power lines. Villagers can access fresh water from one spigot at the side of the Module. At the other side of the Module, green ammonia can be tapped for fertilizing local crops through a safety-locked value designed to release ammonia directly and safely into portable tanks.

IV. (1.2) Wind Light Module 2

Module 2 houses the green ammonia synthesis function, depicted here as a one-megawatt scaled Solid State Ammonia Synthesis system producing an estimated 3.2 tons of ammonia per day at full capacity. The solid-state ammonia synthesis system rests in a separated chamber at the top of the Module separated from the tanking system below by a steel floor.

Module 2 also includes a green ammonia fuel tank, a water tank that surrounds the ammonia tank and provides protection from ammonia leaks. A fourth element is an in-take system pumping water up from the underground well into the water tank.

Embedded sensors monitor water and ammonia levels in the tanks, as well as any indication of ammonia or water leakage. The information is sent remotely to Wind Light managers in the village and via satellite uplink to a central information management center which constantly monitors all aspects of Wind Light Hub operations from many separate sites. If information indicates problems have developed, a team is dispatched to help the village manager assess and repair the problem.

The sides of the module are covered in flexible solar sheaths that are positioned to capture sunlight throughout daylight hours. The solar sheaths are protected from damage by a translucent composite. Power is collected from the solar sheaths and distributed up to the ammonia synthesis operation to keep the thermal temperatures of the synthesis system sufficiently “warm” to be ready for fast restart when high altitude or terrestrial wind becomes available to power the solid-state ammonia synthesis operation.

There is the option of injecting both hot water vapor and separated nitrogen into the solid-state ammonia synthesis process from the emission of the ammonia-fueled generators in Module 1. This is designed to improve the efficiency of the solid-state ammonia synthesis system.

IV. (1.3) Wind Light Module 3

Wind and solar power are integrated at the top of the Wind Light Hub in Module 3.

Here power control and conditioning systems will take the high voltage AC electric output of the wind turbine, along with the output of the solar sheaths, and reshape them into the lower voltage, higher-amplitude or higher amperage DC energy required by the solid-state ammonia synthesis system. This is also where power will be integrated from the High Altitude Wind Generator (not pictured) operating in the jet stream at near 90% capacity and sending power to a platform adjacent to the Wind Light Tower.

When the wind blows, the solid-state ammonia synthesis system takes water from the tank as a source of hydrogen, nitrogen from the atmosphere through an air separation unit, and electricity from the high altitude and terrestrial wind turbines and solar sheaths. Energy, water and air are synthesized into green anhydrous ammonia. The ammonia is diverted into the tank inside the tower.

In the spring, this ammonia is diverted through the outlet in Module 1 into mobile tanks that spread the ammonia on the nearby fields nearby, fertilizing the crops. Local farm equipment and small trucks can be designed to run using ammonia as a fuel. Sensors will alert local managers if ammonia in the tank approaches levels that may threaten minimum fuel requirements for the ongoing power requirements of the village.

Village electric power is created from the ammonia-fueled generators in Module 1. Fresh water vapor generated as emissions from the power generators is condensed and recycled back into the water tank. The village uses the clean, potable water for personal consumption, or to help water crops in a drought. This can help disrupt cycle of poverty caused by seasonal droughts and create net produce beyond village needs for sale to others—increasing the wealth, health and independence of the community.

V. WATER-BASED, DISAGGREGATED HUBS PARTIALLY CONNECTED TO THE POWER GRID. Much of the earth's renewable energy resources are located above or within large bodies of water. Ocean and water based Hydrogen Hubs—referred to here as Hydro Hubs—can uniquely help capture this energy.

Hydro Hubs

Hydrogen Hub ammonia synthesis operations can be placed on production platforms on large-scale bodies of fresh water or in the ocean, or floated out on ships designed and built specifically for this purpose. Hydro Hubs can be built on a scale that can respond to vast global energy requirements.

As identified in FIG. 3, the off shore waters of the United States have thousands of square miles of Class 5-7 wind sites. Floating Hub ammonia synthesis operations—on platforms or ships designed for the purpose—can integrate energy from large-scale wind turbine arrays, high altitude wind generators, tidal, wave, ocean thermal temperatures and other renewable energy resources.

Hydro Hubs can capture this otherwise lost energy without the need for large-scale, expensive and power transmission facilities to ship the energy back to the mainland. It is often the power transmission system capital demands, environmental impacts, and delays that cause delays in water-based energy solutions.

Instead, Hydro Hubs can synthesize the energy into green ammonia at very large scale. The green ammonia will be shipped in ocean-going barges and ammonia tankers back to port cities. Here, the green ammonia will fuel large and small-scale, distributed, grid-connected Hub generation sites creating zero emissions near the center of load.

V. (1) Ocean-Based Hydro Hub Ammonia Synthesis Platforms

Ocean and water based, gigawatt-scale Hydro Hubs can be placed on retired oil platforms presently on the ocean, on new platforms designed specifically for this purpose. Hydrogen Hub designated zones off shore and in international waters can be established to manufacture, trade and transport water, energy and ammonia on a potentially global scale.

An expansion of the Hydrogen Hub network to ocean-based systems will vastly increase the size and scope of such key Hub elements as the Hub Water Exchange Market, the Hub Code Green (HCG) tracking system, the Green Ammonia Exchange (GME), the Green Ammonia Derivatives Market, and many others. In addition to stationary platforms, barges and ships can be configured to function as floating, fully integrated, highly flexible and potentially portable Hydrogen Hubs.

The solid-state ammonia synthesis process produces 3.2 tons of ammonia per megawatt per day. There is the equivalent energy of 150 gallons of diesel fuel per ton of ammonia. Therefore, a 1,000-megawatt Hub synthesis plant would produce ammonia equal to 480,000 gallons of diesel fuel per day—or 175 million gallons per year. Two hundred and thirty such plants would produce the equivalent of 40 billion gallons of diesel fuel used each year in the United States from all sources. There are ammonia river and ocean barges that hold between 500 and 3,000 ton of ammonia. Ocean going ships can carry tens of thousands of metric tons of ammonia.

This fleet of barges and ship can be configured to bring out water from the mainland to use as a hydrogen source in the ocean-based Hub synthesis plant. They can return to port carrying green ammonia. These barges and ships can return to urban-centered, specifically designed Hub ports and provide sufficient fuel storage to power Hydrogen Hub generation sites ranging up hundreds of megawatts or more in size. The large-scale Hub power sites can be distributed throughout complex urban centers and together can help meet the peak power needs of major cities. Once this network is more mature, Hydrogen Hubs designed to power neighborhoods and homes can further strengthen and “smarten” the power grid of the 21st century.

VI. AN INTEGRATED GRID-AGRICULTURE-TRANSPORTATION HYDROGEN HUB GLOBAL NETWORK. Once the Hydrogen Hub-based ammonia distribution systems branch out further into urban areas they can reach into neighborhoods, and finally the home. This neighborhood-based network of smaller scaled, zero-emissions Hydrogen Hub power generation systems forms the backbone of new Hydrogen Hub micro-grids of the future.

VI. (1) Hydrogen Hub Micro Grids

Distributed networks of Hydrogen Hub generation systems will form an energy web of micro grids managed and controlled by smart technology. Ultra-safe manufacture and storage of ammonia in home-based Hydrogen Hubs sets the stage for independently powered houses, home-grid power exchange agreements, and the increased protection of the power grid from cascading blackouts. Individual consumers can control electric power generation and for the first time. Hub power generation systems provide power to neighborhoods, homes, farms, substations, hospitals or other key commercial and industrial facilities.

The existing power grid is designed to break down into separate islands of power control—Independent Operating Power Regions (IOPRs). These IOPRs can form the basis for new Hydrogen Hub micro grids. Individual homeowners can use Web 2.0 technologies, for example, to aggregate themselves into neighborhood-based independent power providers—selling zero-pollution power and collective energy efficiency guarantees back to the central grid manager and receiving payments in return. When predetermined consumer price points are met, or when emergency back up power is needed, Hub-based smart technologies can automatically trigger power generation to meet these needs.

With Hydrogen Hub technology consumers can help shape a new energy web—controlling for the first time in history the use, price and generation of electricity in real time from the center of load.

VI. (2) Green Fuel Transportation Network

Once a Hydrogen Hub network is placed to meet the needs of the power grid and agriculture, the network can become a fuel distribution system for new cars and trucks designed to run on pure anhydrous ammonia. Hydrogen Hub synthesis systems deployed for power generation in the home can also act as fueling tanks for a new vehicle in the driveway. These vehicles will run on internal combustion engines and fuel cells powered by ammonia—often from renewable resources—with zero pollution at the source of use.

To the extent the Hub identified that the ammonia was “tagged” as created by green power sources such as hydropower and wind, for example, the cars would be powered by entirely renewable energy. If the cost of the green ammonia can be reduced to $500 a ton through increased scale and operating efficiencies in the ammonia synthesis process, the cost of running the car on ammonia would be roughly equal to the car running on diesel fuel costing $3.33 per gallon. This price is well within the recent range of diesel fuel prices between 2008 and 2009. This price comparison does not include potential carbon credits or other benefits associated with running cars or trucks on non-carbon fuel.

Estimates on the potential cost of carbon emissions vary. The Congressional Budget Office estimated in 2008 that a carbon cap and trade system then being considered by Congress would range start at $23 a ton and rise to $44 a ton by 2018. According to the CBO, this would create over $900 billion in carbon allowances—or costs—in the first decade of the proposed carbon cap and trade system.

A fully deployed and distributed Hydrogen Hub network can reach from isolated ocean platforms and wind farms of the central plains to home garages in the largest cities. If this occurs, the costs of the new carbon-free ammonia fuel network will be shared by the three largest industries in the world—the electric power, agriculture, and transportation industries. Sharing capital costs of the Hydrogen Hub network among these global industries offers the potential for reducing the overall costs of energy, food and transportation for billions of consumers while helping sustain the planet.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. An energy conversion module, comprising:
an input energy coupling system configured to receive energy in a first state; and
a state-change module configured to utilize the input energy to produce potential energy in a second state.

2. The energy conversion module of claim 1 wherein the energy is received off the peak of its demand.

3. The energy conversion module of claim 1 wherein the energy is received from a source of renewable energy.

4. The energy conversion module of claim 3 wherein the source of renewable energy is selected from hydropower, wind power and solar power energy sources.

5. The energy conversion module of claim 1 wherein the energy is received from a utility grid.

6. The energy conversion module of claim 1 wherein the system is off-grid, isolated and self-sufficient.

7. The energy conversion module of claim 1 wherein the state-change module produces ammonia via an electrolysis-air separation Haber-Bosch process.

8. The energy conversion module of claim 1 wherein the state-change module produces ammonia via a solid state ammonia synthesis reaction.

9. A method of converting and transmitting energy, comprising:
inputting energy into a conversion module,
producing ammonia from the input energy at a site of production,
decreasing the amount of ammonia produced in the producing step when the demand for energy used in the inputting step increases above a predetermined threshold, and
generating electric power from the ammonia produced in the producing step, at a site of utilization.

10. A method of converting and transmitting energy, comprising:
inputting energy from a first source of renewable energy, and energy from a second source of non-renewable energy, into a conversion module at a production site,
producing ammonia from the first and second sources of energy at the production site,
tracking the relative amounts of energy used from the first and second sources to produce ammonia at the production site, and
generating electric power from the ammonia produced in the producing step, at a site of utilization
